(19) United States
(12) Patent Application Publication
(10) Pub. No.: US 2026/0175355 A1
(43) Pub. Date: Jun. 25, 2026

(54) POLISHING PAD, POLISHING METHOD, AND METHOD OF MANUFACTURING POLISHING PAD

(71) Applicant: CANON KABUSHIKI KAISHA, Tokyo (JP)

(72) Inventors: SHOTARO NOMURA, Shizuoka (JP); TAKUMI FURUKAWA, Shizuoka (JP); HIROAKI KOMATSU, Shizuoka (JP); SHOTA SEGAWA, Shizuoka (JP); KENICHI MOCHIZUKI, Shizuoka (JP)

(21) Appl. No.: 19/414,630

(22) Filed: Dec. 10, 2025

(30) Foreign Application Priority Data
Dec. 25, 2024 (JP) 2024-229429

(51) Int. Cl. B24B 37/26; B24B 37/24; B29C 41/04; B29L 31/00

(52) U.S. Cl. CPC B24B 37/26; B24B 37/24; B29C 41/04; B29L 2031/736

(57) ABSTRACT

Provided is a polishing pad, which is excellent in polishing rate and also excellent in maintainability of the polishing rate. The polishing pad has a surface where a bubble area ratio is maximum. The average aspect ratio of the openings of recesses derived from a plurality of bubbles in the surface where the bubble area ratio is maximum is 1.00 or more and 2.00 or less. The total value of the area-equivalent circle diameters of the openings of the recesses derived from the plurality of bubbles per unit area in the surface where the bubble area ratio is maximum is 9.0 mm/mm² or more and 61.0 mm/mm² or less. The bubble area ratio in the surface where the bubble area ratio is maximum is 55 area % or more and 95 area % or less.

### BACKGROUND

### Field of the Technology

The present disclosure relates to a polishing pad, a polishing method, and a method of manufacturing a polishing pad.

### Description of the Related Art

Hitherto, polishing with free abrasive grains has been performed as a method for precisely polishing the surface of an object to be polished, such as: a glass substrate used in, for example, a lens or a display mask blank; a semiconductor wafer including a compound semiconductor wafer, such as silicon, silicon carbide, gallium nitride, gallium oxide, or diamond; a semiconductor device including a silicon oxide insulating film and a metal, such as copper, tungsten, or any other barrier metal; or a hard disk, to perform pattern transfer or planarization.

In the polishing with the free abrasive grains, the following mode is generally adopted: a slurry containing the free abrasive grains is supplied between the object to be polished and a polishing pad, and during the supply, the object to be polished and the polishing pad are oscillated and brought into abutment with each other while being individually rotated.

In order to improve the productivity of the polishing with the free abrasive grains, an improvement in polishing rate has been required. The polishing may proceed when the abrasive grains in the slurry are brought into abutment with the object to be polished by the pad. Accordingly, the improvement in polishing rate is expected by increasing the number of sites where the abrasive grains are brought into abutment with the object to be polished by the pad.

In, for example, Japanese Patent No. 6439958, there is a disclosure of an approach to controlling the length of each of the edge parts of minute hollow spherical bodies on the polishing surface of a polishing pad because the edge parts contribute to polishing. In addition, in Japanese Patent No. 6196773, attention is paid to a contact area between a pad and an object to be polished, and an attempt is made to improve the polishing rate of the pad through the increase of the contact area with an organic fiber filler.

However, the configurations of the above-mentioned patent publications have been insufficient from the viewpoint of attempting a further improvement in polishing rate. In addition, the value of the polishing rate is preferably stable during dressing, but each of the configurations of the above-mentioned patent publications has been required to be further improved in terms of the stability.

### SUMMARY

The present disclosure is directed to providing a polishing pad, which is excellent in polishing rate and also excellent in maintainability of the polishing rate. The present disclosure is also directed to providing a polishing method, which is excellent in polishing rate and also excellent in maintainability of the polishing rate. The present disclosure is also directed to providing a method of manufacturing a polishing pad, which is excellent in polishing rate and also excellent in maintainability of the polishing rate.

In order to solve the above-mentioned problems, the present disclosure provides a polishing pad for polishing an object to be polished with free abrasive grains, the polishing pad including a resin sheet having a plurality of bubbles, wherein, when a plurality of cross-sections, which are parallel to a surface on a side for polishing the object to be polished, are determined every 4 μm in a depth direction toward a surface on a side opposite to the surface on the side for polishing the object to be polished from a measurement result of X-ray CT of the resin sheet, and a total value of areas of openings of recesses derived from the plurality of bubbles per unit area in each of the plurality of cross-sections is defined as a bubble area ratio, the resin sheet has, out of the plurality of cross-sections, a surface where the bubble area ratio is maximum, wherein, in the surface where the bubble area ratio is maximum, an average aspect ratio of the openings of the recesses derived from the plurality of bubbles is 1.00 or more and 2.00 or less, wherein, in the surface where the bubble area ratio is maximum, a total value of area-equivalent circle diameters of the openings of the recesses derived from the plurality of bubbles per unit area is 9.0 mm/mm² or more and 61.0 mm/mm² or less, and wherein, in the surface where the bubble area ratio is maximum, the bubble area ratio is 55 area % or more and 95 area % or less.

The present disclosure also provides a polishing method using a polishing pad for polishing an object to be polished with free abrasive grains, the polishing pad being the above-mentioned polishing pad, the polishing method including exposing one of the surface where the bubble area ratio is maximum or a surface in a vicinity thereof from the resin sheet to a surface of the resin sheet when one of the surface where the bubble area ratio is maximum or the surface in the vicinity thereof is unexposed to the surface of the resin sheet.

The present disclosure also provides a method of manufacturing a polishing pad, the method including introducing an uncured resin into a coaxial centrifugal molding apparatus, forming an uncured resin layer on an inner circumferential surface of the coaxial centrifugal molding apparatus with a centrifugal force, and heating and curing the uncured resin layer to produce a resin sheet, wherein the resin sheet has a plurality of bubbles, wherein, when a plurality of cross-sections, which are parallel to a surface on a side for polishing the object to be polished, are determined every 4 μm in a depth direction toward a surface on a side opposite to the surface on the side for polishing the object to be polished from a measurement result of X-ray CT of the resin sheet, and a total value of areas of openings of recesses derived from the plurality of bubbles per unit area in each of the plurality of cross-sections is defined as a bubble area ratio, the resin sheet has, out of the plurality of cross-sections, a surface where the bubble area ratio is maximum, wherein, in the surface where the bubble area ratio is maximum, an average aspect ratio of the openings of the recesses derived from the plurality of bubbles is 1.00 or more and 2.00 or less, wherein, in the surface where the bubble area ratio is maximum, a total value of area-equivalent circle diameters of the openings of the recesses derived from the plurality of bubbles per unit area is 9.0 mm/mm² or more and 61.0 mm/mm² or less, and wherein, in the surface where the bubble area ratio is maximum, the bubble area ratio is 55 area % or more and 95 area % or less.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view for illustrating the concept of a bubble-derived recess of the present disclosure and an opening thereof.

FIG. 1B is a cross-sectional view for illustrating the concept of the bubble-derived recess of the present disclosure and the opening thereof.

FIG. 2 is a conceptual diagram of the area-equivalent circle diameter of the opening of the bubble-derived recess.

FIG. 3 is a configuration example of a centrifugal molding machine to be used in centrifugal molding.

FIG. 4 is a schematic diagram of a method of defining a measurement surface in X-ray CT apparatus measurement and analysis.

### DESCRIPTION OF THE EMBODIMENTS

In the present disclosure, the description “XX or more and YY or less” or “XX to YY” representing a numerical range means a numerical range including a lower limit and an upper limit that are end points unless otherwise stated.

### First Embodiment

A first embodiment is directed to a polishing pad.

The polishing pad according to the present disclosure is a polishing pad for polishing an object to be polished with free abrasive grains, the polishing pad including a resin sheet having a plurality of bubbles, wherein, when a plurality of cross-sections, which are parallel to a surface on a side for polishing the object to be polished, are determined every 4 μm in a depth direction toward a surface on a side opposite to the surface on the side for polishing the object to be polished from a measurement result of X-ray CT of the resin sheet, and a total value of areas of openings of recesses derived from the plurality of bubbles per unit area in each of the plurality of cross-sections is defined as a bubble area ratio, the resin sheet has, out of the plurality of cross-sections, a surface where the bubble area ratio is maximum, wherein, in the surface where the bubble area ratio is maximum, an average aspect ratio of the openings of the recesses derived from the plurality of bubbles is 1.00 or more and 2.00 or less, wherein, in the surface where the bubble area ratio is maximum, a total value of area-equivalent circle diameters of the openings of the recesses derived from the plurality of bubbles per unit area is 9.0 mm/mm² or more and 61.0 mm/mm² or less, and wherein, in the surface where the bubble area ratio is maximum, the bubble area ratio is 55 area % or more and 95 area % or less.

Description is given below.

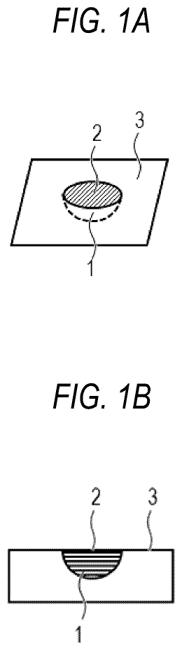

FIG. 1A and FIG. 1B are each a conceptual diagram of a bubble-derived recess and the opening thereof in the surface where the bubble area ratio is maximum or in a surface in the vicinity thereof according to the present disclosure. Although a single bubble-derived recess is illustrated in each of the drawings, a plurality of bubble-derived recesses actually exist.

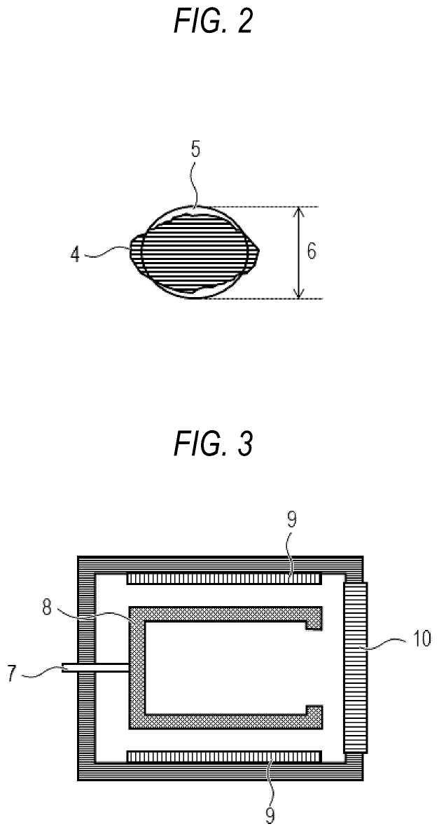

FIG. 2 is a conceptual diagram of the area-equivalent circle diameter of the opening of a bubble-derived recess.

According to an investigation made by the inventors, the above-mentioned polishing pad can provide a polishing pad, which exhibits a polishing rate higher than a conventional polishing rate and is also excellent in maintainability of the polishing rate, and a polishing method using the polishing pad. Details about the foregoing are described below.

Although there are fundamentally various theories regarding the mechanism via which polishing with free abrasive grains proceeds, the polishing is basically performed through the abutment of the abrasive grains with a polishing object by the polishing pad, and an increase in number of sites of the polishing pad each having a function of bringing the abrasive grains into abutment with the object to be polished may contribute to an improvement in polishing rate of the polishing pad.

There are many unresolved aspects of such problems as: the specific location of a site, which has a function of bringing the abrasive grains into abutment with the object to be polished, on the polishing pad; whether or not the site is limited only to a true contact part; and whether or not any other part also has some degree of abutment function in the process of relative movement between the polishing pad and the object to be polished.

There is also a discussion on whether or not the total amount of abutment of the abrasive grains is important, or whether or not a projection diameter with respect to the direction of the relative movement between the polishing pad and the object to be polished is essential.

The inventors have conceived that a factor dominant over the polishing rate is not the simple amount of abutment of the abrasive grains but the projection diameter with respect to the direction of the relative movement between the polishing pad and the object to be polished. This is because when an abrasive grain behind a certain abrasive grain viewed from its movement direction and an abrasive grain arranged in parallel thereto are compared to each other, it seems clear that the latter abrasive grain contributes more to the polishing rate than the former abrasive grain does.

As a result of an investigation, the inventors have found that the total value of the projection diameters of the recesses derived from the bubbles in the surface of the polishing pad where the bubble area ratio is maximum or in a surface in the vicinity thereof with respect to the direction of the relative movement between the polishing pad and the object to be polished has a correlation with the polishing rate.

In particular, when the relative movement between the polishing pad and the object to be polished involves their respective rotational movements, or when the recesses derived from the bubbles are recesses derived from substantially spherical bubbles, anisotropy due to the bubble shape is eliminated, and hence the projection diameter of each of the recesses can be regarded as being equal to the area-equivalent circle diameter of the opening of the recess. Accordingly, the polishing rate is correlated with the total value of the area-equivalent circle diameters of the recesses derived from the bubbles of the polishing pad for the number of the recesses.

Although the details of a principle for the foregoing are not elucidated, it is conceivable that the abrasive grains held in the edge parts of the recesses derived from the bubbles in the polishing pad surface are each supplied to a site having an abutment function preferentially over other abrasive grains in the process of the relative movement, and contribute to polishing. This phenomenon occurs in proportion to the projection diameters in terms of the bubbles, and hence the phenomenon may be correlated with the total value of the area-equivalent circle diameters of the recesses derived from the bubbles in terms of the entirety of the polishing pad.

In view of the above-mentioned finding, the inventors have aimed to improve the total value of the area-equivalent circle diameters of the openings of the recesses derived from the substantially spherical bubbles. Although the improvement was successful from the viewpoint of improving the polishing rate, the improvement alone has been insufficient for maintaining the polishing rate.

As a result of an investigation made by the inventors, it has become clear that the maintenance of a high polishing rate requires a certain degree of opening of a bubble-derived recess in the surface where the bubble area ratio is maximum or in a surface in the vicinity thereof.

The foregoing was considered to be due to the retention of abrasive grains in a slurry in the recesses derived from the bubbles. That is, when a sufficient number of openings derived from bubbles exist, the abrasive grains are appropriately replaced by rolling between the openings, and newly supplied abrasive grains are quickly developed on the pad surface. In addition, deteriorated abrasive grains that have been used in polishing and have undergone wear or aggregation are also discharged relatively quickly from a space between the polishing pad and the object to be polished. As a result of those actions, the polishing rate may be maintained. In contrast, when there are few openings derived from bubbles, the rolling of the abrasive grains between the openings is suppressed. Accordingly, it is conceivable that deteriorated abrasive grains are retained, and the supply of new abrasive grains is suppressed, and hence the polishing rate reduces.

In view of the foregoing, as a result of an investigation, the inventors have found a configuration that maintains a high polishing rate over a long period of time by bringing many abrasive grains into abutment with the object to be polished and suppressing the retention of deteriorated abrasive grains through a bubble distribution that achieves a high total area-equivalent circle diameter and a high opening ratio.

The present disclosure is specifically described below.

The polishing pad according to the present disclosure is a polishing pad for polishing an object to be polished with free abrasive grains. In the present disclosure, the polishing pad includes the resin sheet having a plurality of bubbles.

In the present disclosure, a plurality of cross-sections, which are parallel to the surface on the side for polishing the object to be polished, are determined every 4 μm in a depth direction toward the surface on the side opposite to the surface on the side for polishing the object to be polished from the measurement result of the X-ray CT of the resin sheet, and the total value of the areas of the openings of the recesses derived from the plurality of bubbles per unit area in each of the plurality of cross-sections is defined as a bubble area ratio.

In this case, in the present disclosure, the resin sheet has, out of the plurality of cross-sections, the surface where the bubble area ratio is maximum, and in the resin sheet, the surface where the bubble area ratio is maximum or a surface in the vicinity thereof is unexposed to the surface of the resin sheet, or is exposed to the surface of the resin sheet. In the present disclosure, the surface in the vicinity thereof means a surface in the range of ±200 μm in the depth direction of the surface where the bubble area ratio is maximum. The distribution of the bubbles is continuous. Accordingly, it is conceivable that the surface in the vicinity thereof has bubble-derived recesses substantially equivalent to those of the surface where the bubble area ratio is maximum, and hence the surface exhibits substantially equivalent actions and effects.

A bubble in the surface where the bubble area ratio is maximum or in the surface in the vicinity thereof is schematically illustrated in each of FIG. 1A and FIG. 1B. As illustrated in each of the figures, an opening 2 of a recess derived from a bubble and a recess 1 derived from the bubble are present in the bubble in the surface where the bubble area ratio is maximum or a surface in the vicinity thereof, which is represented by reference numeral 3.

In the present disclosure, in the surface where the bubble area ratio is maximum, the total value of the area-equivalent circle diameters of the openings of the recesses derived from the plurality of bubbles per unit area is preferably 9.0 mm/mm² or more and 61.0 mm/mm² or less, more preferably 9.0 mm/mm² or more and 13.5 mm/mm² or less, still more preferably 9.0 mm/mm² or more and 12.0 mm/mm² or less, particularly preferably 9.0 mm/mm² or more and 11.4 mm/mm² or less.

When the total value falls within the above-mentioned ranges, a high polishing rate is exhibited. When the total value is less than 9.0 mm/mm², a sufficient polishing rate cannot be obtained. A total value of 9.0 mm/mm² or more is more preferred from the viewpoint of exhibiting a high polishing rate.

Here, a view for describing the area-equivalent circle diameter of the opening of a recess derived from a bubble in the present disclosure is illustrated in FIG. 2. An area-equivalent circle diameter 6 of the opening of the recess derived from the bubble may be determined by fitting an area-equivalent circle 5 of an opening 4 of the recess derived from the bubble to the opening of the recess derived from the bubble as in a known method.

In addition, in the present disclosure, in the surface where the bubble area ratio is maximum, the bubble area ratio is 55 area % or more and 95 area % or less, preferably 55 area % or more and 94 area % or less.

When the bubble area ratio falls within the above-mentioned ranges, the polishing rate is maintained over a long period of time. When the bubble area ratio is less than 55 area %, an initial polishing rate cannot be sufficiently maintained. In addition, when the bubble area ratio is more than 95 area %, a resin part between the openings becomes fragile, and the shape of the site of the polishing pad having a function of bringing the abrasive grains into abutment with the object to be polished is unstable during its polishing. Accordingly, the polishing rate reduces and the polishing rate cannot be maintained. A bubble area ratio of 70 area % or more is preferred because the polishing rate is more satisfactorily maintained.

In the present disclosure, in the surface where the bubble area ratio is maximum, the average aspect ratio of the openings of the recesses derived from the plurality of bubbles is 1.00 or more and 2.00 or less, preferably 1.00 or more and 1.60 or less, more preferably 1.00 or more and 1.50 or less.

When the average aspect ratio falls within the above-mentioned ranges, a stable polishing rate can be exhibited irrespective of the anisotropy of relative movement between the polishing pad and the object to be polished. When the average aspect ratio is more than 2.00, a stable polishing rate cannot be exhibited depending on the anisotropy of the relative movement.

In the surface where the bubble area ratio is maximum, the average area-equivalent circle diameter Da of the recesses derived from the plurality of bubbles is preferably 20 μm or more and 200 μm or less, more preferably 60 μm or more and 160 μm or less, still more preferably 70 μm or more and 140 μm or less, particularly preferably 75 μm or more and 133 μm or less. Such setting enables efficient supply of the slurry abrasive grains stored in the recesses derived from the bubbles to the edge parts, and hence can improve the polishing rate.

When the Da is 50 μm or more, the retentivity of the slurry is satisfactory, and the polishing rate is stabilized.

In the present disclosure, the Asker A hardness of the resin sheet measured at 25° C. with an indenter having a tip diameter of 0.79 mm is preferably 40 or more, more preferably 60 or more, still more preferably 70 or more, particularly preferably 90 or more. Such setting stabilizes the abutment of the slurry abrasive grains with the object to be polished, and hence enables stable exhibition of a high polishing rate.

When the Asker A hardness is 60 or more, a high polishing rate and the stability thereof can be exhibited.

### Second Embodiment

A second embodiment is directed to a method of manufacturing a polishing pad.

The method of manufacturing a polishing pad according to the present disclosure is a method of manufacturing a polishing pad, the method including a step of introducing an uncured resin into a coaxial centrifugal molding apparatus, forming an uncured resin layer on an inner circumferential surface of the coaxial centrifugal molding apparatus with a centrifugal force, and heating and curing the uncured resin layer to produce a resin sheet, wherein the resin sheet has a plurality of bubbles, wherein, when a plurality of cross-sections, which are parallel to a surface on a side for polishing an object to be polished, are determined every 4 μm in a depth direction toward a surface on a side opposite to the surface on the side for polishing the object to be polished from a measurement result of X-ray CT of the resin sheet, and a total value of areas of openings of recesses derived from the plurality of bubbles per unit area in each of the plurality of cross-sections is defined as a bubble area ratio, the resin sheet has, out of the plurality of cross-sections, a surface where the bubble area ratio is maximum, wherein, in the surface where the bubble area ratio is maximum, an average aspect ratio of the openings of the recesses derived from the plurality of bubbles is 1.00 or more and 2.00 or less, wherein, in the surface where the bubble area ratio is maximum, a total value of area-equivalent circle diameters of the openings of the recesses derived from the plurality of bubbles per unit area is 9.0 mm/mm² or more and 61.0 mm/mm² or less, and wherein, in the surface where the bubble area ratio is maximum, the bubble area ratio is 55 area % or more and 95 area % or less.

Description of the items described in the first embodiment is omitted because the description overlaps with that in the second embodiment.

The method of manufacturing a polishing pad according to the present disclosure includes the step of introducing the uncured resin into the coaxial centrifugal molding apparatus, forming the uncured resin layer on the inner peripheral surface of the coaxial centrifugal molding apparatus with a centrifugal force, and heating and curing the uncured resin layer to produce the resin sheet. Such setting enables the formation of recess structures derived from the above-mentioned bubbles in the surface where the bubble area ratio is maximum.

In the method of manufacturing a polishing pad according to the present disclosure, in the above-mentioned step, the centrifugal force applied by the coaxial centrifugal molding apparatus is preferably 200 m/s² or more and 4,000 m/s² or less, and the viscosity of the uncured resin to be introduced into the coaxial centrifugal molding apparatus is preferably 1,000 mPa·s or more and 20,000 mPa·s or less. Such setting enables the formation of a bubble distribution for forming recesses derived from the above-mentioned bubbles in the surface of the resin sheet where the bubble area ratio is maximum.

A material for the resin sheet to be used in the present disclosure is specifically described below.

The material for the resin sheet is not particularly limited as long as the material is a thermosetting resin, and one or two or more kinds of, for example, a polyurethane resin composition, a polyacrylic resin composition, a polycarbonate resin composition, a polyamide resin composition, a polyester resin composition, and a polyepoxy resin composition may be used.

The polyurethane resin composition includes a structure in which an active hydrogen group-containing compound and an isocyanate group-containing compound are alternately repeated as constituent units.

The active hydrogen group-containing compound is an organic compound having an active hydrogen group that can react with an isocyanate group. Specific examples of the active hydrogen group include functional groups, such as a hydroxy group, a primary amino group, a secondary amino group, and a thiol group. The active hydrogen groups may be present in plural kinds and in a plural number in the active hydrogen group-containing compound.

Examples of the active hydrogen group-containing compound include a polyol compound and a polyamine compound.

Examples of the polyol compound include a linear aliphatic glycol, a branched aliphatic glycol, an alicyclic diol, a polyfunctional polyol, a polyester polyol, a polyester polycarbonate polyol, a polyether polyol, a polycarbonate polyol, and a polyfunctional polyol polymer.

Examples of the linear aliphatic glycol include 1,4-benzenedimethanol, 1,4-bis(2-hydroxyethoxy)benzene, ethylene glycol, propylene glycol, 1,3-propanediol, 1,3-butanediol, 1,5-pentanediol, 3-methyl-1,5-pentanediol, 1,6-hexanediol, 1,8-octanediol, and 1,9-nonanediol.

Examples of the branched aliphatic glycol include neopentyl glycol, 3-methyl-1,5-pentanediol, 2-methyl-1,3-propanediol, 2-butyl-2-ethyl-1,3-propanediol, and 2-methyl-1,8-octanediol.

Examples of the alicyclic diol include 1,4-cyclohexanediol, 1,4-cyclohexanedimethanol, and hydrogenated bisphenol A.

Examples of the polyfunctional polyol include glycerin, trimethylolpropane, tributylolpropane, pentaerythritol, and sorbitol.

Examples of the polyester polyol include polyethylene adipate glycol, polybutylene adipate glycol, polycaprolactone polyol, and polyhexamethylene adipate glycol.

The polyester polycarbonate polyol is, for example, a reaction product of a polyester glycol such as polycaprolactone polyol, and an alkylene carbonate. The polyester polycarbonate polyol may also be, for example, a reaction product obtained by further causing a reaction mixture, which is obtained by causing ethylene carbonate to react with a polyhydric alcohol, to react with an organic dicarboxylic acid.

Examples of the polyether polyol include polytetramethylene ether glycol, polypropylene glycol, polyethylene glycol, and ethylene oxide-added polypropylene polyol.

The polycarbonate polyol is, for example, a reaction product of a diol, such as 1,3-propanediol, 1,4-butanediol, 1,6-hexanediol, diethylene glycol, polyethylene glycol, polypropylene glycol, or polytetramethylene ether glycol, and phosgene, a diaryl carbonate (e.g., diphenyl carbonate), or a cyclic carbonate (e.g., propylene carbonate).

Examples of the polyamine compound include 4,4′-methylenebis(2-chloroaniline) (MOCA), 4,4′-methylenedianiline, trimethylene bis(4-aminobenzoate), 2-methyl-4,6-bis(methylthio)benzene-1,3-diamine, 2-methyl-4,6-bis(methylthio)-1,5-benzenediamine, 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-diethyltoluene-2,4-diamine, 3,5-diethyltoluene-2,6-diamine, trimethylene glycol-di-p-aminobenzoate, 1,2-bis(2-aminophenylthio)ethane, and 4,4′-diamino-3,3′-diethyl-5,5′-dimethyldiphenylmethane.

Examples of the isocyanate group-containing compound include an aromatic diisocyanate, an aliphatic diisocyanate, an alicyclic diisocyanate, and a urethane prepolymer.

Examples of the aromatic diisocyanate include tolylene diisocyanate (TDI), 1,5-naphthalene diisocyanate, xylylene diisocyanate, 1,3-phenylene diisocyanate, and 1,4-phenylene diisocyanate. The examples of the aromatic diisocyanate also include diphenylmethane diisocyanate (MDI) and a modified product of diphenylmethane diisocyanate (MDI).

Examples of the modified product of diphenylmethane diisocyanate (MDI) include a carbodiimide-modified product, a urethane-modified product, an allophanate-modified product, a urea-modified product, a biuret-modified product, an isocyanurate-modified product, and an oxazolidone-modified product. Such modified product is specifically, for example, carbodiimide-modified diphenylmethane diisocyanate (carbodiimide-modified MDI).

Examples of the aliphatic diisocyanate include ethylene diisocyanate, 2,2,4-trimethylhexamethylene diisocyanate, and hexamethylene diisocyanate (HDI).

Examples of the alicyclic diisocyanate include 1,4-cyclohexane diisocyanate, 4,4′-dicyclohexylmethane diisocyanate, isophorone diisocyanate, norbornane diisocyanate, and methylenebis(4,1-cyclohexylene) diisocyanate.

A urethane prepolymer is a polymer formed by bonding a polyol and a polyisocyanate, and has an isocyanate group as a terminal group.

The resin sheet may contain a filler.

Specific examples of the filler include: inorganic powder, such as aluminum oxide, cerium oxide, titanium oxide, germanium oxide, silicon carbide, calcium carbonate, silica, carbon black, diamond, talc, or clay; inorganic fibers, such as a glass fiber and a carbon fiber; metal powder, such as iron, copper, aluminum, or nickel; metal fibers, such as an iron fiber, a copper fiber, and an aluminum fiber; organic fibers, such as a polyimide fiber, a TEFLON (trademark) fiber, and a polyester fiber; organic pigments such as an azo-based pigment; and other materials generally used in polymer chemistry, such as a gas, a fluid, and resin powder. A plurality of kinds of those fillers may be simultaneously incorporated into the resin sheet.

The amount of the filler is preferably 0.1 parts by mass or more and 40.0 parts by mass or less with respect to 100 parts by mass of the resin.

The particle diameter of the filler is preferably 10 nm or more and 500 nm or less.

The resin sheet may contain a foam stabilizer.

The foam stabilizer is, for example, a silicone-based surfactant, and one or two or more kinds of such surfactants may be used. Examples thereof include “Toray Silicone SH-193,” “Toray Silicone SH-192,” and “Toray Silicone SH-190” manufactured by Dow Corning Toray Co., Ltd.

In addition to the above-mentioned materials, a stabilizer such as an antioxidant, a lubricant, a pigment, a filler, an antistatic agent, and other additives may each be added to the resin sheet as required.

Examples of a method of forming the recesses derived from the plurality of bubbles in the surface of the resin sheet of the polishing pad where the bubble area ratio is maximum include: mechanical foaming in which an inert gas is mixed into the uncured resin; and chemical foaming in which a foaming agent typified by water is added thereto. A hollow microcapsule or the like, which itself becomes a bubble, may also be added thereto.

Examples of the inert gas to be used in the mechanical foaming include nitrogen, oxygen, a carbon dioxide gas, a noble gas, such as helium or argon, and a mixed gas thereof such as air.

As a stirring apparatus for dispersing the inert gas in the form of fine bubbles in the mechanical foaming, a known stirring apparatus may be used without any particular limitation, and specific examples thereof include a homogenizer, a dissolver, a biaxial planetary mixer (planetary mixer), and a mechanical froth foaming machine. The shape of the stirring blade of the stirring apparatus is also not particularly limited, and the stirring blade is, for example, a whipper-type stirring blade.

Examples of the foaming agent in the chemical foaming include, in addition to water, a foaming agent containing, as a main component, a hydrocarbon having 5 or 6 carbon atoms, an organic chemical foaming agent, and a halogenated hydrocarbon.

Examples of the hydrocarbon include: chain hydrocarbons, such as butane, n-pentane, and n-hexane; and alicyclic hydrocarbons, such as cyclopentane and cyclohexane.

Examples of the organic chemical foaming agent include an azo-based compound, a nitroso compound, and a sulfonyl hydrazide compound.

Examples of the azo-based compound include azodicarbonamide, azobisisobutyronitrile, diazoaminobenzene, and barium azodicarboxylate.

Examples of the nitroso compound include N,N′-dinitrosopentamethylenetetramine and N,N′-dinitroso-N,N′-dimethylterephthalamide.

Examples of the sulfonyl hydrazide compound include p,p′-oxybis(benzenesulfonyl hydrazide) and p-toluenesulfonyl hydrazide.

Examples of the halogenated hydrocarbon include methylene chloride and hydrofluorocarbons (HFCs).

The hollow microcapsules include pre-expanded hollow microcapsules and unexpanded hollow microcapsules. The unexpanded hollow microcapsules are heat-expandable microcapsules, and can be heated and expanded.

Examples of commercially available hollow microcapsules include, but not limited to, an Expancel series (product name, manufactured by Akzo Nobel N.V.) and Matsumoto Microsphere (product name, manufactured by Matsumoto Yushi-Seiyaku Co., Ltd.).

A hollow microcapsule obtained through synthesis by an ordinary method may also be used. A material for the outer shell of a hollow microcapsule 4A is not particularly limited, and examples thereof include polyvinyl alcohol, polyvinylpyrrolidone, poly(meth)acrylic acid, polyacrylamide, polyethylene glycol, polyhydroxyether acrylate, a maleic acid copolymer, polyethylene oxide, polyurethane, poly(meth)acrylonitrile, polyvinylidene chloride, polyvinyl chloride, and an organic silicone-based resin, and a copolymer obtained by combining two or more kinds of monomers for forming these resins.

The methods of manufacturing the resin sheet of the polishing pad are roughly divided into a method including cutting a sheet out of a bulk and a method including molding the resin into a sheet shape in advance.

Examples of the latter method include a method including casting an uncured resin into a sheet-shaped mold and a method including molding the uncured resin into a sheet shape with an external stress.

The external stress is, for example, a centrifugal force, and examples of the method using the external stress include: spin coating in which a rotation axis is vertical and the uncured resin is spread in a horizontal direction; and a centrifugal molding method in which a cylindrical mold with a horizontal rotation axis rotates, and the resin is poured from the direction of the rotation axis into the mold and spread on the surface of the cylindrical mold. In the present disclosure, the centrifugal molding method is preferred.

The centrifugal molding method is specifically a method of molding a thin-walled cylindrical sheet by: introducing a raw material for the resin sheet that is uncured into a cylindrical mold; rotating the mold at a high speed to form a resin raw material layer on its inner peripheral surface with a centrifugal force; and heating and curing the layer. The cylindrical sheet thus obtained is removed as a molded article from the cylindrical mold, subjected to secondary crosslinking as required, and cut into desired dimensions and a desired shape as required. Examples of a method for the cutting include known cutting methods, such as a clicker blade, a laser, and a cutter.

A configuration example of a centrifugal molding machine to be used in centrifugal molding is illustrated in FIG. 3. That is, as the centrifugal molding machine, there may be used a machine formed so as to include: a driving shaft 7 rotated by a motor or the like; a mold 8 in the form of a cylindrical cup attached to, and rotatably supported by, the tip of the driving shaft; a heat source 9 such as a heater fixedly arranged on the outer periphery of the mold 8; and a hatch 10 opened in a case covering the mold 8 and the heat source 9.

The control of the distribution of the bubbles is achieved by comprehensively controlling foaming by heating from the surface of the cylindrical mold of the coaxial centrifugal molding machine and the movement of the bubbles by a centrifugal force in accordance with formulation factors, such as the viscosity of the resin, the amount and timing of the foaming thereof, and the ratio control of the competing reactions of the curing and foaming thereof, and operating conditions, such as the intensity level of the centrifugal force and the time period for which the centrifugal force is applied. The temperature of the cylindrical mold should be appropriately changed in accordance with the viscosity and foaming characteristics of the material to be used. For example, when the curing speed of the resin sheet is wished to be increased, the temperature should be raised. However, the temperature needs to be changed in accordance with purposes because a balance between the foaming and curing of the resin sheet shows different characteristics from material to material.

In addition, the number of revolutions of the cylindrical mold controls the effect of a centrifugal force caused by rotation, but the number should also be appropriately changed in accordance with the viscosity and foaming characteristics of the material to be used. For example, when it is desired to increase the foaming rate of the resin sheet on the inner surface side of the cylindrical mold, the number of revolutions may be increased to increase the centrifugal force, to thereby promote the accumulation of bubbles. In addition, when it is desired to reduce the foaming diameter of the resin sheet, the number of revolutions may be increased to increase the centrifugal force, to thereby promote the rupture of large-diameter bubbles. In addition, the same applies when it is desired to uniformize the distribution of the foaming diameters thereof. The number of revolutions may also be changed in a stepwise manner in accordance with the state of the curing or foaming of the resin.

The rotation time of the cylindrical mold should be appropriately controlled in accordance with the degree to which the effect of the above-mentioned centrifugal force is exhibited.

The method of manufacturing a polishing pad according to the present disclosure preferably includes a step of exposing the surface where the bubble area ratio is maximum or a surface in the vicinity thereof from the resin sheet to the surface of the resin sheet when the surface where the bubble area ratio is maximum or the surface in the vicinity thereof is unexposed to the surface of the resin sheet. At least, the surface where the bubble area ratio is maximum or the surface in the vicinity thereof needs to be exposed to the surface of the resin sheet before its use as a polishing pad. Any method may be used as a method for the exposure as long as the cross section can be exposed. In the present disclosure, the term “surface in the vicinity thereof” means a surface in the range of ±200 μm in the depth direction from the surface where the bubble area ratio is maximum.

### Third Embodiment

A third embodiment is directed to a polishing method.

A polishing method according to the present disclosure is a polishing method using a polishing pad for polishing an object to be polished with free abrasive grains, the polishing pad being the polishing pad of the present disclosure, the polishing method including a step of exposing the surface where the bubble area ratio is maximum or a surface in the vicinity thereof from the resin sheet to the surface of the resin sheet when the surface where the bubble area ratio is maximum or the surface in the vicinity thereof is unexposed to the surface of the resin sheet.

Description of the items described in the first embodiment and the second embodiment is omitted because the description overlaps with that in the third embodiment.

The polishing method according to the present disclosure is a polishing method using a polishing pad for polishing an object to be polished with free abrasive grains, the polishing pad being the polishing pad of the present disclosure. A specific example thereof is described.

First, the polishing method according to the present disclosure includes the step of exposing the surface where the bubble area ratio is maximum or the surface in the vicinity thereof to the surface of the resin sheet when the surface where the bubble area ratio is maximum or the surface in the vicinity thereof is unexposed to the surface of the resin sheet. At the time of polishing, the surface where the bubble area ratio is maximum or the surface in the vicinity thereof needs to be exposed to the surface of the resin sheet. Any method may be used as a method for the exposure as long as the cross section can be exposed. In the present disclosure, the term “surface in the vicinity thereof” means a surface in the range of 200 μm in the depth direction from the surface where the bubble area ratio is maximum.

Next, the object to be polished is held on the holding platen of a polishing machine. Next, the polishing pad is mounted on a polishing platen arranged to face the holding platen. When the polishing pad has a double-sided tape and release paper, at the time of the mounting of the polishing pad on the polishing platen, the release paper is peeled from the double-sided tape to expose the pressure-sensitive adhesive layer of the double-sided tape, and then the exposed pressure-sensitive adhesive layer is brought into contact with, and pressed against, the polishing platen. Then, the object to be polished is polished with the free abrasive grains by: supplying a polishing slurry containing the abrasive grains as required between the object to be polished and the polishing pad; and rotating the polishing platen or the holding platen while pressing the object to be polished against the polishing pad at a predetermined polishing pressure.

The polishing slurry is not particularly limited, and may be a slurry to be used in conventional chemical mechanical polishing, and general abrasive grains may be used as the abrasive grains in accordance with the object to be polished. Examples thereof include ceria, silica, alumina, manganese oxide, diamond, and organic-inorganic composite abrasive grains. The abrasive grains are used alone or in combination thereof.

### [Measurement Methods and Calculation Methods for Respective Physical Properties]

Measurement methods and calculation methods for various physical properties of the polishing pad and the material are described below.

### <Measurement Method for Average Aspect Ratio>

### Acquisition of Shape Data

A strip-shaped piece measuring 2 cm wide by 5 cm long (piece 11 of a resin sheet for X-ray CT imaging) was prepared from the resin sheet of the polishing pad, and was set in an X-ray CT apparatus (TXS-32300FDHS manufactured by Toshiba IT Control Systems Corporation), followed by X-ray CT measurement. Measurement conditions are described below.
X-ray tube voltage [KV]: 75.000
X-ray tube voltage [mA]: 0.053
Data mode: CONE
FC function: Laks
Scan mode: FULL
Number of views: 2,000
Slice interval: 0.004
Integration: 1

### Definition of Measurement Surface

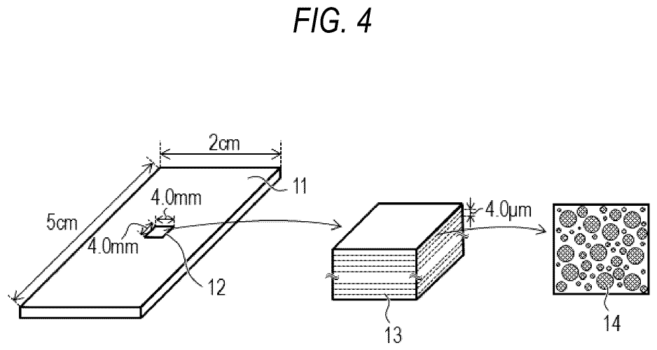

Shape data obtained for an X-ray CT imaging region 12 in the above-mentioned measurement was analyzed with image processing software VGStudio Max 2.1 manufactured by Nihon Visual Science Volume Graphics Co., Ltd., and a region measuring 4.0 mm by 4.0 mm on the maximum-area surface of the resin sheet was sliced every 4.0 μm in its depth direction. Thus, a measurement surface 13, which was the sliced X-ray CT imaging region, was obtained. An outline of a method of defining the measurement surface up to this point is illustrated in FIG. 4.

Recesses derived from bubbles and a resin part were classified by binarization processing through contrast adjustment on each of the resultant cut surfaces, and the total value of the areas of the openings of the recesses derived from the bubbles (openings 14 of the recesses derived from the bubbles on the measurement surface) each having a size of 2 μm or more was calculated. The ratio of the total value was calculated by dividing the total value by the area of the entire region.

When the surface where the area ratio of the openings of the recesses derived from the bubbles was maximum or a surface in the vicinity thereof was defined as the measurement surface, the measurement surface was determined from the above-mentioned data.

In addition, when the outermost surface of the resin sheet was defined as the measurement surface, a cut surface obtained as follows was defined as the measurement surface: when the entirety of the measurement surface was set to 100%, the resin sheet was sliced from its surface side until a void part accounting for 10% or more of the entirety disappeared.

### Measurement of Average Aspect Ratio

The data on the 4.0 mm×4.0 mm measurement surface obtained in the above-mentioned measurement was subsequently analyzed with image processing software VGStudio Max 2.1 manufactured by Nihon Visual Science Volume Graphics Co., Ltd., and the circumferential portions of the recesses derived from the bubbles each having a size of 2 μm or more in the surface where the area ratio of the openings of the recesses derived from the bubbles was maximum or a surface in the vicinity thereof were sampled, followed by the calculation of their average aspect ratio. The average of at least 50 bubble-derived recesses is calculated, and when the number of bubble-derived recesses in the measurement surface is 50 or less, a plurality of samples are subjected to the measurement, and the average value of 50 or more bubble-derived recesses is calculated.

### <Measurement Method for Area-Equivalent Circle Diameter>

### Acquisition of Shape Data

The X-ray CT measurement of the resin sheet was performed in the same manner as in the measurement of the average aspect ratio to provide data on a 4.0 mm×4.0 mm measurement surface.

### Measurement of Area-Equivalent Circle Diameter

The data on the 4.0 mm×4.0 mm measurement surface obtained in the above-mentioned measurement was analyzed with ImageJ (Rasband, W.S., U.S. National Institutes of Health, Bethesda, Maryland, USA), and recesses derived from bubbles and a resin part in the surface where the area ratio of the openings of the recesses derived from the bubbles was maximum or a surface in the vicinity thereof were classified by binarization processing through contrast adjustment. The area-equivalent circle diameters of the recesses derived from the bubbles each having a size of 2 μm or more on the 4.0 mm×4.0 mm measurement surface were calculated, and their average value was calculated. The average of at least 50 bubble-derived recesses is calculated, and when the number of bubble-derived recesses in the measurement surface is 50 or less, a plurality of samples are subjected to the measurement, and the average value of 50 or more bubble-derived recesses is calculated.

### <Calculation Method for Ratio of Total Value of Areas of Openings>

### Acquisition of Shape Data

The X-ray CT measurement of the resin sheet was performed in the same manner as in the measurement of the average aspect ratio to provide data on a 4.0 mm×4.0 mm measurement surface.

### Calculation of Ratio of Total Value of Areas of Openings

The data on the 4.0 mm×4.0 mm measurement surface obtained in the above-mentioned measurement was analyzed with image processing software VGStudio Max 2.1 manufactured by Nihon Visual Science Volume Graphics Co., Ltd., and the total value of the areas of the openings of recesses derived from bubbles each having a size of 2 μm or more in the data on the 4.0 mm×4.0 mm measurement surface was calculated. The ratio of the total value was calculated by dividing the total value by the area of the entire region of the 4.0 mm×4.0 mm measurement surface.

### <Measurement Method for Asker A Hardness of Resin Sheet at 25° C.>

To eliminate the influence of a sheet-placing stand on a measured value, the resin sheet laminated to a thickness of 6 mm or more was allowed to stand still for 16 hours under an environment at 25° C. and a humidity of 50%±5%. After that, the hardness of the resin sheet was measured five times with a type A durometer conforming to JIS K 6253 (Asker A type manufactured by Kobunshi Keiki Co., Ltd.), and the average value of the measured values was adopted as the Asker A hardness of the resin sheet.

### <Measurement Method for Resin Viscosity>

The viscosity of the resin sheet 60 seconds after its melting was measured with VP-500 manufactured by HAAKE Co., Ltd. An apparatus and conditions for the measurement are as described below.
Viscometer: rotational viscometer Viscotester VT550 (manufactured by HAAKE Co., Ltd.)
Sensor system: NV cup/NV rotor
Number of revolutions: 8.3 s⁻¹ (500 rpm)
Circulating constant temperature bath: open bath circulator DC5-K20 (manufactured by HAAKE Co., Ltd.)
Set temperature: 70° C.

### <Evaluation Methods for Initial Polishing Rate and Polishing Rate Transition>

The surface of the produced polishing pad 1 was subjected to so-called X-Y groove processing (lattice groove processing) with a width of 2.0 mm, a pitch of 15 mm, and a depth of 0.5 mm, and the polishing pad 1 was mounted on a CMP polishing apparatus (“NF-300HP” manufactured by Nanofactor Co., Ltd.).

Next, under the conditions of a platen revolution number of 60 rpm, a head revolution number of 61 rpm, and a polishing pressure of 70 g/cm², a #100 diamond dish was attached to the head of the polishing apparatus, and the initial dressing of the pad was performed for 1 minute. The dressing was not performed throughout the subsequent evaluations.

Next, under the conditions of a platen revolution number of 60 rpm, a head revolution number of 61 rpm, and a polishing pressure of 140 g/cm², while a silica (SiO₂) slurry (manufactured by Fujimi Incorporated) was supplied at a rate of 100 ml/min, a wafer in which a SiO₂ film having a thickness of 5,000 Å was formed on the (100) surface of monocrystalline silicon having a diameter of 4 inches was polished for 2 minutes, 20 minutes, and 40 minutes, followed by the measurement of the polishing rate of the polishing pad.

In the present disclosure, the phrase “excellent in maintainability of the polishing rate” means that the polishing rate does not reduce relatively with a polishing time, and for example, means that a difference between the polishing rate after polishing for 2 minutes and the polishing rate after polishing for 40 minutes is relatively small.

### EXAMPLES

The present disclosure is more specifically described below by way of Examples. However, the present disclosure is by no means limited by Examples. In the following formulations, the term “part(s)” means “part(s) by mass” unless otherwise specified.

### Example 1

237 Parts by mass of 2,4-tolylene diisocyanate (TDI), 412 parts by mass of polytetramethylene ether glycol (PTMG) having a number-average molecular weight of about 1,000, and 40 parts by mass of diethylene glycol were caused to react with each other, and the reaction product was degassed under heating and reduced pressure to provide a prepolymer. The isocyanate content of the prepolymer was 9.1%.

55.0 Parts by mass of the prepolymer, 45.0 parts by mass of diethyl toluene diamine (DETDA), 5.0 parts by mass of water, 0.006 parts by mass of TOYOCAT (trademark) ET (manufactured by Tosoh Corporation), and 2.0 parts by mass of a silicone-based foam stabilizer SH-193 were mixed to provide an uncured resin solution.

340 Grams of the uncured resin solution was heated to 110° C. on a preformed silicone rubber release layer, and was poured into a cylindrical mold having a diameter of 450 mm and a depth of 320 mm in a centrifugal molding machine rotating at 1,200 rpm. While the number of revolutions was maintained at 1,200 rpm for 30 minutes from the time point when the pouring was completed, the solution was cured under heating. After that, the cured product was removed from the mold to provide a resin sheet 1 having a thickness of 1.50 mm.

A double-sided tape having adhesive layers (material: acrylic resin) on both the surfaces of a PET-made substrate, and further having release paper on one surface thereof was bonded to a surface opposite to the surface of the resultant resin sheet 1 where its bubble area ratio was maximum or a surface in the vicinity thereof via the adhesive layer opposite to the release paper, and the laminate was cut into a circular shape having a diameter of 300 mm to provide a polishing pad 1. Table 1-1 shows the formulation and manufacturing conditions of the resultant polishing pad 1. In addition, Table 2-1 shows the physical properties of the resultant polishing pad 1.

TABLE 1-1

| | | Polishing | Polishing | Polishing | Polishing | Polishing | Polishing |
|---|---|---|---|---|---|---|---|
| | | pad 1 | pad 2 | pad 3 | pad 4 | pad 5 | pad 6 |
| Formulation | TDI | 237 | 237 | 237 | 237 | 237 | 237 |
| | [part(s) by mass] | | | | | | |
| | PTMG | 412 | 412 | 412 | 412 | 412 | 412 |
| | [part(s) by mass] | | | | | | |
| | Diethylene glycol | 40 | 40 | 40 | 40 | 40 | 40 |
| | [part(s) by mass] | | | | | | |
| | Prepolymer | 55 | 55 | 59 | 60 | 56 | 57 |
| | [part(s) by mass] | | | | | | |
| | DETDA | 45 | 45 | 41 | 40 | 44 | 43 |
| | [part(s) by mass] | | | | | | |
| | Water | 5 | 5 | 4.5 | 4 | 5.5 | 6 |
| | [part(s) by mass] | | | | | | |
| | TOYOCAT ET | 0.006 | 0.006 | 0.006 | 0.006 | 0.006 | 0.006 |
| | [part(s) by mass] | | | | | | |
| | Foam stabilizer | 2 | 2 | 2.2 | 2.2 | 1.8 | 1 |
| | [part(s) by mass] | | | | | | |
| | Resin viscosity | 2,129 | 2,934 | 1,698 | 1,476 | 1,683 | 1,692 |
| | [mPa · s] | | | | | | |
| Centrifugal | Number of | 1,200 | 600 | 1,200 | 1,200 | 700 | 600 |
| molding | revolutions | | | | | | |
| apparatus | [rpm] | | | | | | |
| operating | Time | 30 | 30 | 30 | 30 | 30 | 30 |
| conditions | [min] | | | | | | |
| | Mold set | 110 | 110 | 110 | 110 | 110 | 110 |
| | temperature | | | | | | |
| | [° C.] | | | | | | |

TABLE 1-2

| | | Polishing | Polishing | Polishing | Polishing | Polishing | Polishing |
|---|---|---|---|---|---|---|---|
| | | pad 7 | pad 8 | pad 9 | pad 10 | pad 11 | pad 12 |
| Formulation | TDI | 237 | 237 | 237 | 237 | 237 | 237 |
| | [part(s) by mass] | | | | | | |
| | PTMG | 412 | 412 | 412 | 412 | 412 | 412 |
| | [part(s) by mass] | | | | | | |
| | Diethylene glycol | 40 | 40 | 40 | 40 | 40 | 40 |
| | [part(s) by mass] | | | | | | |
| | Prepolymer | 55 | 55 | 55 | 55 | 55 | 55 |
| | [part(s) by mass] | | | | | | |
| | DETDA | 45 | 45 | 45 | 45 | 45 | 45 |
| | [part(s) by mass] | | | | | | |
| | Water | 3.5 | 6 | 4.8 | 3 | 6.5 | 4.5 |
| | [part(s) by mass] | | | | | | |
| | TOYOCAT ET | 0.006 | 0.006 | 0.006 | 0.006 | 0.006 | 0.006 |
| | [part(s) by mass] | | | | | | |
| | Foam stabilizer | 2.4 | 2 | 2 | 2.4 | 2 | 2 |
| | [part(s) by mass] | | | | | | |
| | Resin viscosity | 1,667 | 2,598 | 2,456 | 2,975 | 2,757 | 2,874 |
| | [mPa · s] | | | | | | |
| Centrifugal | Number of | 1,200 | 1,200 | 1,200 | 1,200 | 1,200 | 1,200 |
| molding | revolutions | | | | | | |
| apparatus | [rpm] | | | | | | |
| operating | Time | 150 | 30 | 30 | 210 | 30 | 30 |
| conditions | [min] | | | | | | |
| | Mold set | 110 | 110 | 110 | 110 | 110 | 110 |
| | temperature | | | | | | |
| | [° C.] | | | | | | |

TABLE 2-1

| | Pol- | Pol- | Pol- | Pol- |
|---|---|---|---|---|
| | ishing | ishing | ishing | ishing |
| | pad 1 | pad 2 | pad 3 | pad 4 |
| Average aspect ratio of openings of | 1.21 | 1.24 | 1.25 | 1.23 |
| recesses derived from a plurality of | | | | |
| bubbles | | | | |
| Ratio of total value of area- | 9.5 | 9.1 | 9.4 | 9.2 |
| equivalent circle diameters of | | | | |
| openings of recesses derived | | | | |
| from the plurality of bubbles per | | | | |
| unit area [mm/mm²] | | | | |
| Bubble area ratio in surface where | 84% | 82% | 70% | 65% |
| bubble area ratio is maximum | | | | |
| Average area-equivalent circle | 105 | 114 | 96 | 91 |
| diameter Da of openings of | | | | |
| recesses derived from the plurality | | | | |
| of bubbles [μm] | | | | |
| Asker A hardness of the resin sheet | 92 | 63 | 40 | 35 |
| measured with indenter having tip | | | | |
| diameter of 0.79 mm at 25° C. | | | | |

TABLE 2-2

| | Pol- | Pol- | Pol- | Pol- |
|---|---|---|---|---|
| | ishing | ishing | ishing | ishing |
| | pad 5 | pad 6 | pad 7 | pad 8 |
| Average aspect ratio of openings of | 1.21 | 1.24 | 1.23 | 1.21 |
| recesses derived from a plurality of | | | | |
| bubbles | | | | |
| Ratio of total value of area- | 9.4 | 9.0 | 9.3 | 11.4 |
| equivalent circle diameters of | | | | |
| openings of recesses derived | | | | |
| from the plurality of bubbles per | | | | |
| unit area [mm/mm²] | | | | |
| Bubble area ratio in surface where | 92% | 94% | 55% | 94% |
| bubble area ratio is maximum | | | | |
| Average area-equivalent circle | 125 | 133 | 75 | 105 |
| diameter Da of openings of | | | | |
| recesses derived from the plurality | | | | |
| of bubbles [μm] | | | | |
| Asker A hardness of the resin sheet | 82 | 75 | 92 | 90 |
| measured with indenter having tip | | | | |
| diameter of 0.79 mm at 25° C. | | | | |

TABLE 2-3

| | Pol- | Pol- | Pol- | Pol- |
|---|---|---|---|---|
| | ishing | ishing | ishing | ishing |
| | pad 9 | pad 10 | pad 11 | pad 12 |
| Average aspect ratio of openings of | 1.26 | 1.24 | 1.29 | 1.23 |
| recesses derived from a plurality of | | | | |
| bubbles | | | | |
| Ratio of total value of area- | 9.0 | 9.0 | 13.1 | 8.5 |
| equivalent circle diameters of | | | | |
| openings of recesses derived | | | | |
| from the plurality of bubbles per | | | | |
| unit area [mm/mm²] | | | | |
| Bubble area ratio in surface where | 75% | 53% | 96% | 70% |
| bubble area ratio is maximum | | | | |
| Average area-equivalent circle | 106 | 76 | 104 | 107 |
| diameter Da of openings of | | | | |
| recesses derived from the plurality | | | | |
| of bubbles [μm] | | | | |
| Asker A hardness of the resin sheet | 92 | 94 | 90 | 89 |
| measured with indenter having tip | | | | |
| diameter of 0.79 mm at 25° C. | | | | |

Tables 3-1 and 3-2 show the results of the evaluations of the initial polishing rate and polishing rate transition of each of the polishing pads.

TABLE 3-1

| | Example 1 | Example 2 | Example 3 | Example 4 | Example 5 | Example 6 |
|---|---|---|---|---|---|---|
| Used polishing | Polishing | Polishing | Polishing | Polishing | Polishing | Polishing |
| pad | pad 1 | pad 2 | pad 3 | pad 4 | pad 5 | pad 6 |
| Polishing rate | 1,621 | 1,636 | 1,658 | 1,393 | 1,580 | 1,415 |
| at 2 min | | | | | | |
| [nm/min] | | | | | | |
| Polishing rate | 1,590 | 1,600 | 1,453 | 1,342 | 1,572 | 1,372 |
| at 20 min | | | | | | |
| [nm/min] | | | | | | |
| Polishing rate | 1,529 | 1,546 | 1,359 | 1,193 | 1,453 | 1,323 |
| at 40 min | | | | | | |
| [nm/min] | | | | | | |

TABLE 3-2

| | Example | Example | Example | Comparative | Comparative | Comparative |
|---|---|---|---|---|---|---|
| | 7 | 8 | 9 | Example 1 | Example 2 | Example 3 |
| Used polishing | Polishing | Polishing | Polishing | Polishing | Polishing | Polishing |
| pad | pad 7 | pad 8 | pad 9 | pad 10 | pad 11 | pad 12 |
| Polishing rate | 1,585 | 1,676 | 1,448 | 1,251 | 1,589 | 1,256 |
| at 2 min | | | | | | |
| [nm/min] | | | | | | |
| Polishing rate | 1,431 | 1,572 | 1,411 | 1,169 | 1,154 | 1,200 |
| at 20 min | | | | | | |
| [nm/min] | | | | | | |
| Polishing rate | 1,354 | 1,411 | 1,364 | 1,031 | 1,090 | 1,034 |
| at 40 min | | | | | | |
| [nm/min] | | | | | | |

### Examples 2 to 9

Polishing pads 2 to 9 were each obtained in exactly the same manner as in Example 1 except that the formulation, and the rotation condition and rotation time of the cylindrical mold were changed as shown in Tables 1-1 and 1-2. Tables 2-1, 2-2 and 2-3 show the physical properties of the resultant polishing pads 2 to 9.

Tables 3-1 and 3-2 show the evaluation results of the resultant polishing pads 2 to 9.

### Comparative Examples 1 to 3

Polishing pads 10 to 12 were each obtained in exactly the same manner as in Example 1 except that the formulation, and the rotation condition and rotation time of the cylindrical mold were changed as shown in Table 1-2. Table 2-3 shows the physical properties of the resultant polishing pads 10 to 12.

Table 3-2 shows the evaluation results of the resultant polishing pads 10 to 12.

The average aspect ratio of the openings of the recesses derived from the bubbles, the total value of the area-equivalent circle diameters, and the total value of the areas of the openings in each of Examples 1 to 9 satisfied the definition of claim 1, and hence each of Examples 1 to 9 showed satisfactory values in the initial polishing rate and the polishing rate transition. Example 1 was particularly satisfactory.

The average aspect ratio of the openings of the recesses derived from the bubbles, the total value of the area-equivalent circle diameters, and the total value of the areas of the openings in each of Comparative Examples 1 to 3 did not satisfy the definition of claim 1, and hence each of Comparative Examples 1 to 3 showed low values in the initial polishing rate and the polishing rate transition.

According to the present disclosure, there can be provided a polishing pad, which exhibits a polishing rate higher than a conventional polishing rate and is also excellent in maintainability of the polishing rate, and a polishing method using the polishing pad.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-229429, filed Dec. 25, 2024, which is hereby incorporated by reference herein in its entirety.

What is claimed is:

1. A polishing pad for polishing an object to be polished with free abrasive grains,
the polishing pad comprising a resin sheet having a plurality of bubbles,
wherein, when a plurality of cross-sections, which are parallel to a surface on a side for polishing the object to be polished, are determined every 4 μm in a depth direction toward a surface on a side opposite to the surface on the side for polishing the object to be polished from a measurement result of X-ray CT of the resin sheet, and a total value of areas of openings of recesses derived from the plurality of bubbles per unit area in each of the plurality of cross-sections is defined as a bubble area ratio, the resin sheet has, out of the plurality of cross-sections, a surface where the bubble area ratio is maximum,
wherein, in the surface where the bubble area ratio is maximum, an average aspect ratio of the openings of the recesses derived from the plurality of bubbles is 1.00 or more and 2.00 or less,
wherein, in the surface where the bubble area ratio is maximum, a total value of area-equivalent circle diameters of the openings of the recesses derived from the plurality of bubbles per unit area is 9.0 mm/mm² or more and 61.0 mm/mm² or less, and
wherein, in the surface where the bubble area ratio is maximum, the bubble area ratio is 55 area % or more and 95 area % or less.

2. The polishing pad according to claim 1, wherein, in the surface where the bubble area ratio is maximum, an average area-equivalent circle diameter Da of the openings of the recesses derived from the plurality of bubbles is 20 μm or more and 200 μm or less.

3. The polishing pad according to claim 1, wherein an Asker A hardness of the resin sheet at 25° C. is 40 or more.

4. A polishing method using a polishing pad for polishing an object to be polished with free abrasive grains, the polishing pad being the polishing pad of claim 1, the polishing method comprising exposing one of the surface where the bubble area ratio is maximum or a surface in a vicinity thereof from the resin sheet to a surface of the resin sheet when one of the surface where the bubble area ratio is maximum or the surface in the vicinity thereof is unexposed to the surface of the resin sheet.

5. A method of manufacturing a polishing pad, the method comprising introducing an uncured resin into a coaxial centrifugal molding apparatus, forming an uncured resin layer on an inner circumferential surface of the coaxial centrifugal molding apparatus with a centrifugal force, and heating and curing the uncured resin layer to produce a resin sheet,
wherein the resin sheet has a plurality of bubbles,
wherein, when a plurality of cross-sections, which are parallel to a surface on a side for polishing an object to be polished, are determined every 4 μm in a depth direction toward a surface on a side opposite to the surface on the side for polishing the object to be polished from a measurement result of X-ray CT of the resin sheet, and a total value of areas of openings of recesses derived from the plurality of bubbles per unit area in each of the plurality of cross-sections is defined as a bubble area ratio, the resin sheet has, out of the plurality of cross-sections, a surface where the bubble area ratio is maximum,
wherein, in the surface where the bubble area ratio is maximum, an average aspect ratio of the openings of the recesses derived from the plurality of bubbles is 1.00 or more and 2.00 or less,
wherein, in the surface where the bubble area ratio is maximum, a total value of area-equivalent circle diameters of the openings of the recesses derived from the plurality of bubbles per unit area is 9.0 mm/mm² or more and 61.0 mm/mm² or less, and
wherein, in the surface where the bubble area ratio is maximum, the bubble area ratio is 55 area % or more and 95 area % or less.

6. The method of manufacturing a polishing pad according to claim 5,
wherein the centrifugal force is 200 m/s² or more and 4,000 m/s² or less, and
wherein a viscosity of the uncured resin to be introduced is 1,000 mPa·s or more and 20,000 mPa·s or less.

7. The method of manufacturing a polishing pad according to claim 5, comprising exposing one of the surface where the bubble area ratio is maximum or a surface in a vicinity thereof from the resin sheet to a surface of the resin sheet when one of the surface where the bubble area ratio is maximum or the surface in the vicinity thereof is unexposed to the surface of the resin sheet.
